(19) United States
(12) Patent Application Publication
(10) Pub. No.: US 2002/0171688 A1
(43) Pub. Date: Nov. 21, 2002

(54) Computer mouse with cursor placement device

(76) Inventor: Lawrence J. Koncelik JR., East Hampton, NY (US)

Correspondence Address: Mr. Walter J. Tencza Jr., Suite 3, 10 Station Place, Metuchen, NJ, 08840, US

(21) Appl. No.: 10/170,094

(22) Filed: Jun. 12, 2002

(51) Int. Cl. G09G 5/00

(52) U.S. Cl. 345/856

(57) ABSTRACT

A computer mouse is disclosed having a cursor location switch which when activated causes a cursor on a computer screen to be located at a predetermined position on the computer screen. The predetermined position may correspond to an exit field in a computer software application program. A method is disclosed comprising causing a cursor on a computer screen to be located at a predetermined position on the computer screen in response to activation of a cursor location switch on a computer mouse. The method may include receiving a cursor location signal in response to the activation of the cursor location switch on the computer mouse and causing the cursor on the computer screen to be located at the predetermined position.

### FIELD OF THE INVENTION

This invention relates to improved methods and apparatus concerning devices for a computer mouse.

### BACKGROUND OF THE INVENTION

Typically in the prior art a computer mouse controls the movement of a cursor on a screen of a computer monitor. Typically a ball on the bottom of the computer mouse must be rolled to move the cursor to a particular position on the screen of the computer monitor. In order to select a particular field in for example a particular computer software application, such as Microsoft Word (trademarked) the cursor typically needs to be moved by rolling and needs to be aligned over a small area on the screen. For example, the cursor may be moved by rolling and the cursor may be aligned over the “File” field on a tool bar, in Microsoft Word (trademarked). Such movements of the cursor may be inexact and/or can be a nuisance and may result in the unintentional selection of the wrong field. For example, the “Edit” field may be accidentally selected instead of the “File” field. Although there may be ways to select such fields without using the cursor, such as by using the keyboard, these methods may be hard to remember or more of a nuisance then using the computer mouse.

### SUMMARY OF THE INVENTION

The present invention provides a computer mouse having a cursor location switch which when activated causes a cursor on a computer screen to be located at a predetermined position on the computer screen. The predetermined position on the computer screen may correspond to an exit field in a computer software application program. The present invention can be applied to any computer software application program, including but not limited to Microsoft Word (trademarked), Internet Explorer (trademarked), AOL (“America Online”) (trademarked) web site browser, other internet or web site browsers, or many other computer software applications.

The present invention may further include a computer processor electrically connected to the computer mouse, wherein the computer processor receives a cursor location signal in response to the activation of the cursor location switch on the computer mouse and causes the cursor on the computer screen to be located at the predetermined position. A method is also provided comprising causing a cursor on a computer screen to be located at a predetermined position on the computer screen in response to activation of a cursor location switch on a computer mouse. The method may include receiving a cursor location signal in response to the activation of the cursor location switch on the computer mouse and causing the cursor on the computer screen to be located at the predetermined position.

### BRIEF DESCRIPTION OF THE DRAWINGS

FIG. 1 shows a block diagram of an apparatus, which includes a computer monitor, a computer processor, and a computer mouse, for use in accordance with a first embodiment of the present invention;

FIG. 2 shows the computer mouse and the computer processor for use in the first embodiment of FIG. 1;

FIG. 3 shows a first window that can be displayed on the computer monitor of the embodiment of FIG. 1; and

FIG. 4 shows a modified first window with the cursor shown in a predetermined location in response to activation of a cursor location switch.

### DETAILED DESCRIPTION OF THE DRAWINGS

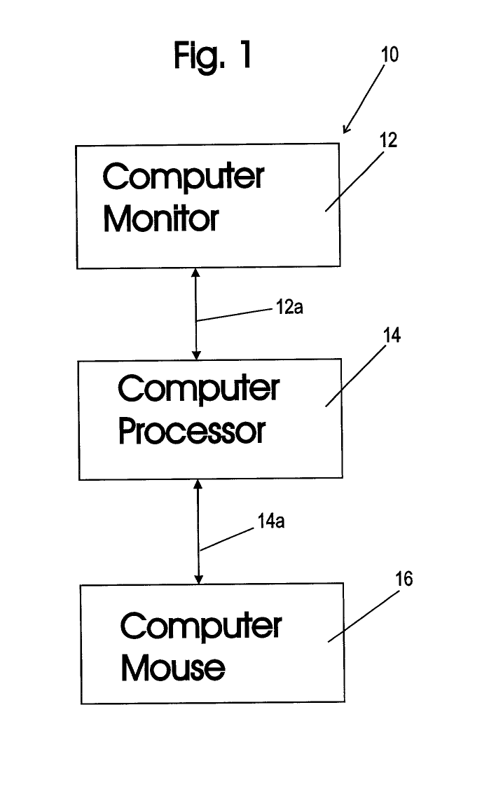

FIG. 1 shows a block diagram of an apparatus 10, which includes a computer monitor 12, a computer processor 14, and a computer mouse 16, for use in accordance with a first embodiment of the present invention. The computer monitor 12 may be electrically connected by a communications link 12a to the computer processor 14. The computer processor 14 may be electrically connected by a communications link 14a to the computer mouse 16. The communications links 12a and 14a may be comprised of one or more of any known communications links, such as but not limited to hardwired conductors, optical connectors, or wireless communications links. The computer processor 14 may be electrically connected to other peripherals such as printers, scanners, and a computer keyboard.

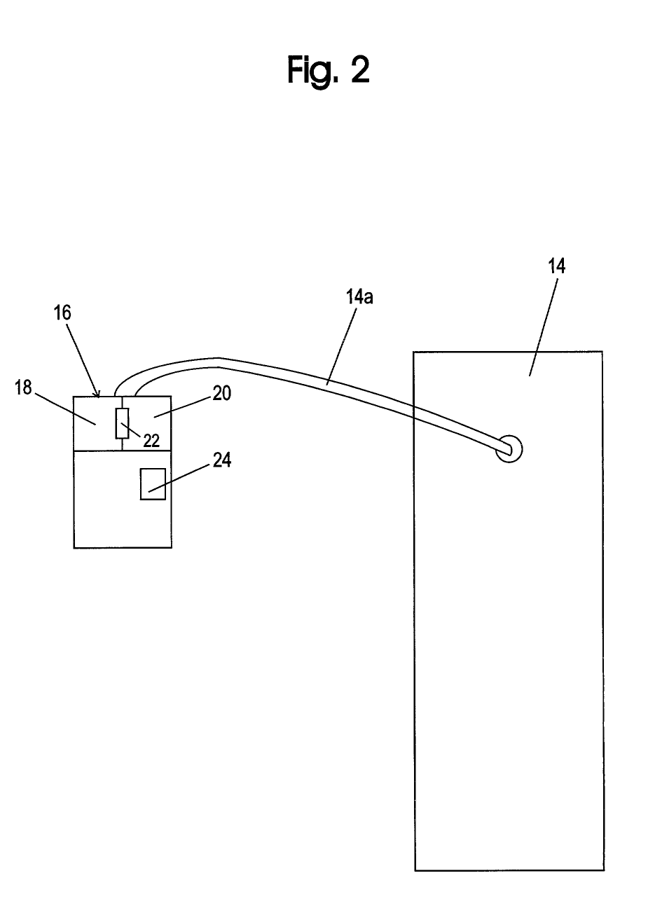

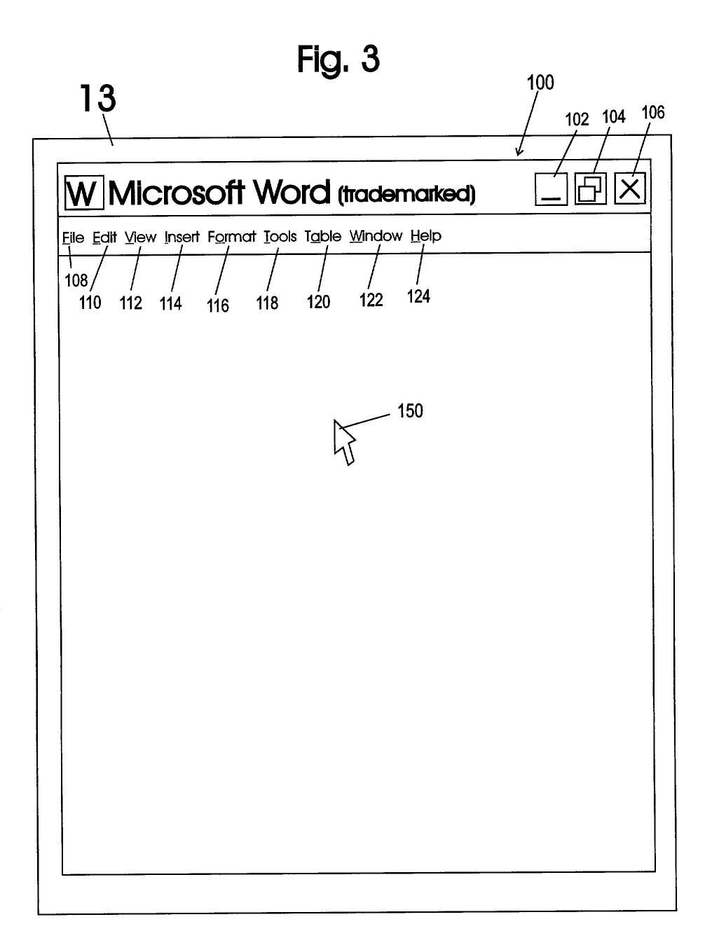

FIG. 2 shows the computer mouse 16 and the computer processor 14 for use in the first embodiment of FIG. 1. The computer mouse 16 includes a left click device 18, a right click device 20, and a page up/down wheel 22. The computer mouse 16 also includes a cursor location switch 24. The cursor location switch 24 may be located anywhere on the computer mouse 16. In accordance with an embodiment of the present invention the cursor location switch 24 can be pressed or clicked to position a cursor at a specific location on a screen of a computer monitor, such as the screen 13 shown in FIG. 3, of the computer monitor 12. In FIG. 2, the communications link 14a, which can be a cable, is shown electrically connecting the computer mouse 16 with the computer processor 14.

FIG. 3 shows the screen 13 of the computer monitor 12. In FIG. 3 the screen 13 shows a window 100 which can be displayed on the computer monitor 12 of the embodiment of FIG. 1. The window 100 is a representation of a window, which can appear in a software application program such as Microsoft Word (trademarked). The window 100 includes fields 102, 104, and 106. The window also includes cursor 150. The cursor 150 can be moved in a conventional manner such as by rolling a ball (not shown) on the bottom of the computer mouse 16 and located over, for example, fields 102, 104, or 106. If the cursor 150 is located over field 102 and the left click device 18 is pressed or clicked on, the window 100 will disappear from the screen 13 as known in the art. A bar at the bottom of the screen 13 may continue to show that the particular Microsoft Word (trademarked) document remains open. If the cursor 150 is located over field 104 and the left click device 18 is pressed or clicked on, the window 100 would become smaller as known in the art. If the cursor 150 is located over field 106 and the left click device 18 is pressed or clicked on, the window 100 would disappear and the computer processor 14 would exit from the computer software application, i.e. in this case exit from Microsoft Word (trademarked).

The window 100 in FIG. 3 also includes fields 108, 110, 112, 114, 116, 118, 120, 122, and 124. As known in the art, when the cursor 150 is located over one of these fields and the left click device 18 is pressed or clicked on, a particular menu of various choices appears on the screen 13.

In accordance with an embodiment of the present invention, when the cursor location switch 24 is activated, pressed or clicked on, a cursor position signal is sent to the computer processor 14 via the communications link 14a. The computer processor 14 is programmed to receive and sense the cursor position signal and to cause the cursor 150 to move to a predetermined location in response to the cursor position signal. For example, the computer processor 14 may be programmed to move the cursor 150 to a location over the field 106. This would allow a user to easily position the cursor 150 over the exit field 106 and to easily exit the computer software program, which in this example is Microsoft Word (trademarked).

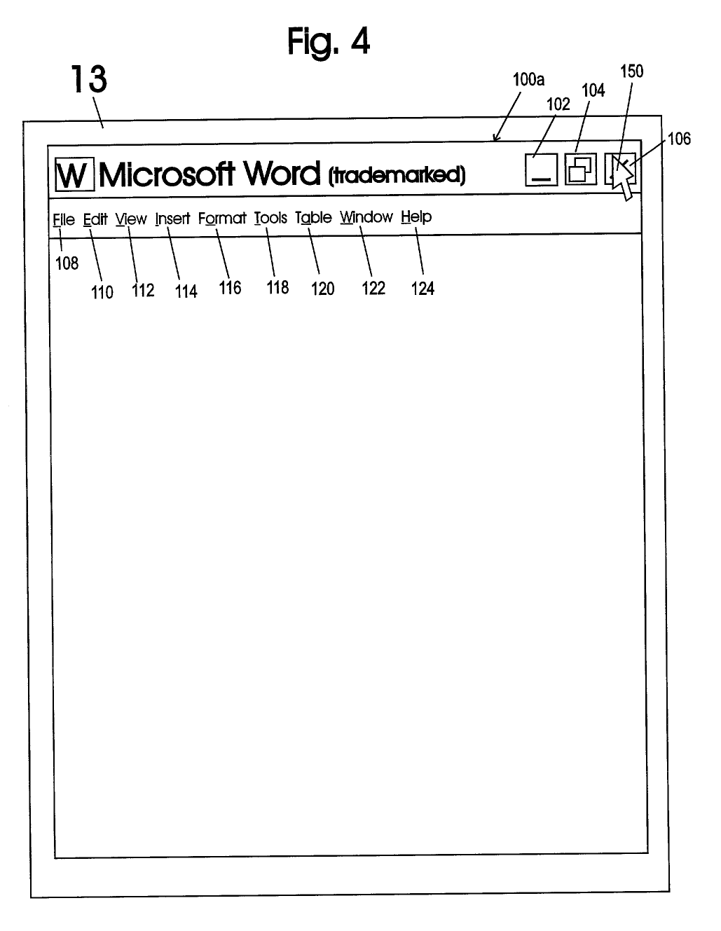

FIG. 4 shows a modified first window 100a with the cursor 150 shown in a predetermined location that is over the exit field 106, in response to activation of the cursor location switch 24.

In a second embodiment of the present invention, one of the switches or devices typically existing in a computer mouse could be used to perform the function of the cursor location switch 24. For example, computer mouse 16 and/or the computer processor 14 can be reprogrammed so that activating, pressing, or clicking on the right click device 20 would cause the cursor 150 to move to a predetermined location on the screen 13 or in the window 100a, such as over the exit field 106 as shown in FIG. 4.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

I claim:

1. An apparatus comprising
a computer mouse having a cursor location switch which when activated causes a cursor on a computer screen to be located at a predetermined position on the computer screen.

2. The apparatus of claim 1 wherein
the predetermined position on the computer screen corresponds to an exit field in a computer software application program.

3. The apparatus of claim 1 further comprising
A computer processor electrically connected to the computer mouse; and
wherein the computer processor receives a cursor location signal in response to the activation of the cursor location switch on the computer mouse and causes the cursor on the computer screen to be located at the predetermined position.

4. A method comprising the step of
causing a cursor on a computer screen to be located at a predetermined position on the computer screen in response to activation of a cursor location switch on a computer mouse.

5. The method of claim 4 wherein
the predetermined position on the computer screen corresponds to an exit field in a computer software application program.

6. The method of claim 4 further comprising
receiving a cursor location signal in response to the activation of the cursor location switch on the computer mouse and causing the cursor on the computer screen to be located at the predetermined position.
